(19) United States
(12) Patent Application Publication
(10) Pub. No.: US 2004/0267529 A1
(43) Pub. Date: Dec. 30, 2004

(54) N-gram spotting followed by matching continuation tree forward and backward from a spotted n-gram

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/601,625

(22) Filed: Jun. 24, 2003

(51) Int. Cl. G10L 15/00

(52) U.S. Cl. 704/252

(57) ABSTRACT

A speech recognition method obtains a list of target speech element sequences each containing at least one speech element. For each target speech element sequence, a forward sequence extension model and a backward sequence extension model is obtained. At least one spotted target speech element sequence is found in a set of acoustic observations by matching it against the sequence of speech element models. From the set of acoustic observations, the set of acoustic observations preceding and following the at least one spotted target speech element sequence is obtained. At least one hypothesis of a longer speech element sequence containing the at least one spotted speech element sequence is obtained as a proper subsequence in which the at least one longer speech element sequence is consistent with at least one of the forward sequence extension model and the backward sequence extension model. The hypothesis of a longer speech element sequence is evaluated based on the degree of acoustic match between the longer speech element sequence and at least one of the set of preceding acoustic observations and following acoustic observations.

### DESCRIPTION OF THE RELATED ART

In a speech recognition system or method that uses a tight pruning bound, it is possible that words are recognized incorrectly by the speech recognizer, such as when the input speech is made in a noisy environment or when the pruning bound used by the speech recognizer is too tight to suit a particular situation.

The present invention is directed to overcoming or at least reducing the effects of the problem set forth above.

### SUMMARY OF THE INVENTION

According to one embodiment of the invention, there is provided a speech recognition method, which includes receiving a set of acoustic observations, and performing a speech recognition on the set of acoustic observations. At the same time the speech recognition is being performed, it is determined whether or not an n-gram of speech elements occurs in the set of acoustic observations, wherein n is an integer greater than or equal to one whose value is chosen to limit the number of false detections based on the expected duration and acoustic distinctiveness of the speech elements in the n-gram. If the determination is that an n-gram occurs, then at least one of a backward search and a forward search is performed using a continuation tree that represents allowable continuations that may precede or follow the spotted n-gram. A best matching path is determined in the continuation tree with respect to the set of acoustic observations, and is output to enhance the speech recognition being performed.

According to another embodiment of the invention, there is provided a speech recognition system, which includes an input unit configured to receive a set of acoustic observations. The system also includes a speech recognition unit configured to perform speech recognition on the set of acoustic observations. The system further includes an n-gram spotting unit configured to spot whether or not at least one n-gram occurs in the set of acoustic observations. The system still further includes a continuation tree processing unit configured to, when the n-gram spotting unit spots at least one n-gram in the set of acoustic observations, perform at least one of a forward search and a backward search at a point in the set of acoustic observations corresponding to the spotted n-gram, by way of a continuation tree, and to provide a best matching path in the continuation tree as an n-gram speech recognition output to the speech recognition unit.

According to yet another embodiment of the invention, there is provided a program product having machine-readable program code for performing speech recognition, the program code, when executed, causing a machine to:

a) receive a set of acoustic observations;

b) perform a speech recognition on the set of acoustic observations;

c) at the same time that step b) is being performed, determine whether or not an n-gram of speech elements occurs in the set of acoustic observations, wherein n is an integer greater than or equal to one whose value is chosen to limit the number of false detections based on the expected duration and acoustic distinctiveness of the speech elements in the n-gram

d) if the determination in step c) is that an n-gram occurs, perform at least one of a backward search and a forward search using a continuation tree that represents allowable continuations that may precede or follow the spotted n-gram; and

e) determine a best matching path in the continuation tree with respect to the set of acoustic observations, and outputting the best matching path to step b) to enhance the speech recognition performed in step b).

### BRIEF DESCRIPTION OF THE DRAWINGS

The foregoing advantages and features of the invention will become apparent upon reference to the following detailed description and the accompanying drawings, of which:

FIG. 1 is a flow chart of an n-gram spotting speech recognition method according to a first embodiment of the invention;

FIG. 2 is a diagram showing a phoneme-level continuation tree that may be used to determine a candidate phoneme n-gram sequence, according to at least one embodiment of the invention;

FIG. 3 is a flow chart of a method of combining speech element sequences according to a second embodiment of the invention;

FIG. 4 is a flow chart of an n-gram spotting speech recognition method according to a third embodiment of the invention;

FIG. 5 is a flow chart of a method of building a forward and a backward extension model according to a fourth embodiment of the invention;

FIG. 6 is a flow chart of an n-gram spotting speech recognition method according to a fifth embodiment of the invention;

FIG. 7 is a flow chart of an n-gram spotting speech recognition method according to a sixth embodiment of the invention;

FIG. 8 is a flow chart of an n-gram spotting speech recognition method according to a seventh embodiment of the invention; and

FIG. 9 is a block diagram of a speech recognition system that can be utilized to perform any of the methods of the invention.

### DETAILED DESCRIPTION OF SPECIFIC EMBODIMENTS

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program,code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

The following terms may be used in the description of the invention and include new terms and terms that are given special meanings.

“Linguistic element” is a unit of written or spoken natural or artificial language. In some embodiments of some inventions, the “language” may be a purely artificial construction with allowed sequences of elements determined by a formal grammar. In other embodiments, the language will be either a natural language or at least a model of a natural language. In a speech recognition task, each linguistic element will generally be associated an interval of speech and thus will also be a speech element. In a handwriting or optical character recognition task, each linguistic element will generally be associated with a sequence of pen strokes or with a portion of an image. In natural language processing tasks based on textual data, each linguistic element will be a unit of written language, such as a word.

“vocabulary” is a set of linguistic elements.

“Speech element” is an interval of speech with an associated name or linguistic element. The name may be the word, syllable or phoneme being spoken during the interval of speech, or may be an abstract symbol such as an automatically generated phonetic symbol that represents the system's labeling of the sound that is heard during the speech interval. As an element within the surrounding sequence of speech elements, each speech element is also a linguistic element.

“Priority queue” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are kept active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is typically a sequence or a combination of sequences of speech elements. Corresponding to any hypothesis is a sequence of models that represent the speech elements. Thus, a match score for any hypothesis against a given set of acoustic observations, in some embodiments, is actually a match score for the concatenation of the models for the speech elements in the hypothesis.

“Look-ahead” is the use of information from a new interval of speech that has not yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Phoneme” is a single unit of sound in spoken language, roughly corresponding to a letter in written language.

“Phonetic label” is the label generated by a speech recognition system indicating the recognition system's choice as to the sound occurring during a particular speech interval. Often the alphabet of potential phonetic labels is chosen to be the same as the alphabet of phonemes, but there is no requirement that they be the same. Some systems may distinguish between phonemes or phonemic labels on the one hand and phones or phonetic labels on the other hand. Strictly speaking, a phoneme is a linguistic abstraction. The sound labels that represent how a word is supposed to be pronounced, such as those taken from a dictionary, are phonemic labels. The sound labels that represent how a particular instance of a word is spoken by a particular speaker are phonetic labels. The two concepts, however, are intermixed and some systems make no distinction between them.

“Spotting” is the process of detecting an instance of a speech element or sequence of speech elements by directly detecting an instance of a good match between the model(s) for the speech element(s) and the acoustic observations in an interval of speech without necessarily first recognizing one or more of the adjacent speech elements.

“Pruning” is the act of making one or more active hypotheses inactive based on the evaluation of the hypotheses. Pruning may be based on either the absolute evaluation of a hypothesis or on the relative evaluation of the hypothesis compared to the evaluation of some other hypothesis.

“Pruning threshold” is a numerical criterion for making decisions of which hypotheses to prune among a specific set of hypotheses.

“Pruning margin” is a numerical difference that may be used to set a pruning threshold. For example, the pruning threshold may be set to prune all hypotheses in a specified set that are evaluated as worse than a particular hypothesis by more than the pruning margin. The best hypothesis in the specified set that has been found so far at a particular stage of the analysis or search may be used as the particular hypothesis on which to base the pruning margin.

“Beam width” is the pruning margin in a beam search system. In a beam search, the beam width or pruning margin often sets the pruning threshold relative to the best scoring active hypothesis as evaluated in the previous frame.

“Best found so far.” Pruning and search decisions may be based on the best hypothesis found so far. This phrase refers to the hypothesis that has the best evaluation that has been found so far at a particular point in the recognition process. In a priority queue search, for example, decisions may be made relative to the best hypothesis that has been found so far even though it is possible that a better hypothesis will be found later in the recognition process. For pruning purposes, hypotheses are usually compared with other hypotheses that have been evaluated on the same number of frames or, perhaps, to the previous or following frame. In sorting a priority queue, however, it is often necessary to compare hypotheses that have been evaluated on different numbers of frames. In this case, in deciding which of two hypotheses is better, it is necessary to take account of the difference in frames that have been evaluated, for example by estimating the match evaluation that is expected on the portion that is different or possibly by normalizing for the number of frames that have been evaluated. Thus, in some systems, the interpretation of best found so far may be based on a score that includes a look-ahead score or a missing piece evaluation.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Language model” is a model for generating a sequence of linguistic elements subject to a grammar or to a statistical model for the probability of a particular linguistic element given the values of zero or more of the linguistic elements of context for the particular speech element.

“General Language Model” may be either a pure statistical language model, that is, a language model that includes no explicit grammar, or a grammar-based language model that includes an explicit grammar and may also have a statistical component.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a non-zero probability.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

The present invention according to several embodiments described below performs n-gram spotting following by matching continuation trees forward and backward from the spotted n-gram. The spotted n-gram may be either a word n-gram or a phoneme n-gram or an n-gram of other kinds of speech elements, depending upon the type of speech recognition processing being performed. That is, depending upon whether a phoneme decoder or a word decoder is being used in a speech recognition method, the present invention would detect the presence of either a phoneme n-gram or a word n-gram. In some embodiments, a speech recognition method may be performing phoneme decoding in one aspect of the overall method and may be performing word decoding in another aspect of the overall method, in which case the present invention may be used both for detecting phoneme n-grams and for detecting word n-grams.

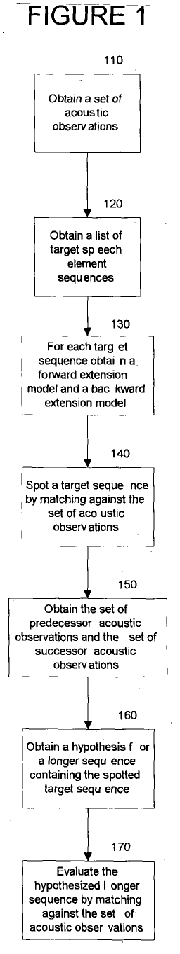

A method of performing speech recognition according to a first embodiment of the invention is shown in FIG. 1. In step 110, a set of acoustic observations is obtained. The set of acoustic observations may be provided by way of a phonetic decoder operating on input speech, for example, or as a second example, the set of acoustic observations may be vectors of acoustic measurements such a set of mel frequency cepstral coefficients. In step 120, a list of target speech element sequences is obtained, and, in step 130, for each target speech element sequence, a forward extension model and a backward extension model is obtained, to be described in more detail with reference to other figures. Steps 120 and 130 are preferably performed prior to step 110, by that does not necessarily have to be the case. The target speech element sequences correspond to particular word n-grams or particular phoneme n-grams, for example.

In step 140, a target sequence is spotted by matching the list of target speech element sequences against the set of acoustic observations. In step 150, the set of predecessor acoustic observations and the set of successor acoustic observations is obtained, with respect to the location in the set of acoustic observations at which the target sequence was spotted.

In step 160, a hypothesis is obtained for a longer sequence containing the target sequence. In step 170, the hypothesized longer sequence is evaluated by matching it against the set of acoustic observations.

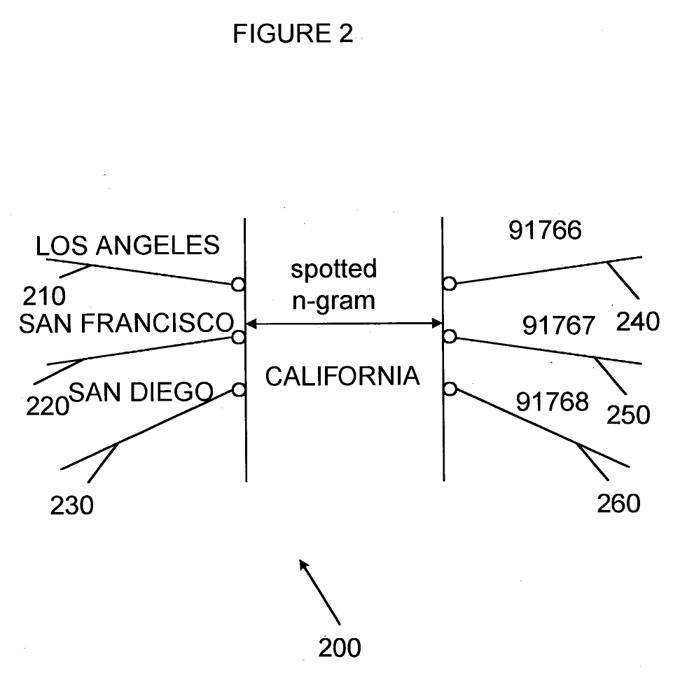

FIG. 2 shows an example of a spotted target sequence, in this case the word “California”. For the spotted target sequence, a backward extension model is obtained based on information obtained beforehand. In this example, the words “Los Angeles” (label 210), “San Francisco” (label 220) and “San Diego” (label 230) are acceptable words in a grammar that can occur before the word “California”, and are used to form the backward extension model. For the spotted target sequence, a forward extension model is obtained, and in this example, the numbers “91766” (label 240), “91767” (label 250) and “91768” (label 260) are acceptable words in a grammar that could occur after the word “California”, and are used to form the forward extension model. The example shown in FIG. 2 may be used to check “City, State and Zip Code” utterances against acceptable phrases that include these three types of information.

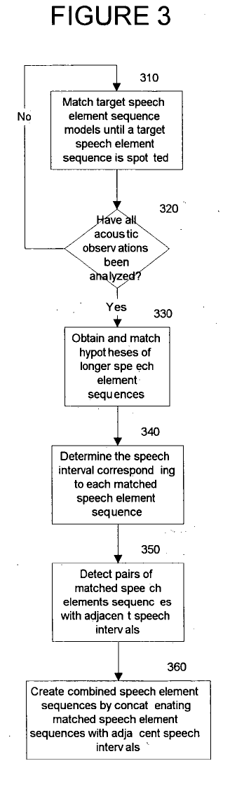

FIG. 3 shows a method of combining speech element sequences according to a second embodiment of the invention. In step 310, a plurality of target speech element sequence models are matched against a set of acoustic observations, until a target speech element sequence is spotted in the set of acoustic observations. Note that more than one target speech element sequence may be spotted in the set of acoustic observations.

In step 320, a determination is made as to whether or not the entire set of acoustic observations has been analyzed. If Yes, then the method proceeds to step 330. If No, then the method returns back to step 310 to evaluate a remaining, non-analzyed portion of the set of acoustic observations.

In step 330, hypotheses of longer speech element sequences are obtained, and then they are matched against the set of acoustic observations. In step 340, a determination is made as to a speech interval corresponding to each matched speech element sequence. In step 350, a determination is made as to whether or not that exists any pairs of matched speech element sequences with adjacent speech intervals. If there exists such a pair of matched speech element sequences in the set of acoustic observations, then in step 360, a combined speech element sequence is created by concatenating the matched speech element sequences with the adjacent speech intervals. The combined speech element sequence can then be provided to a speech processor component, such as a priority queue, for further evaluation along with other hypotheses in the queue.

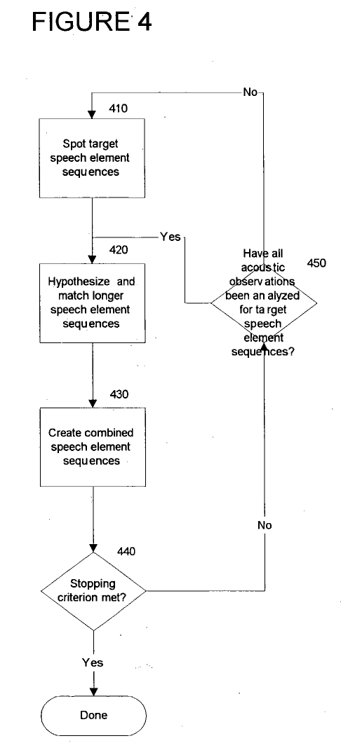

FIG. 4 shows a method of performing speech recognition according to a third embodiment of the invention, which utilizes at least one combined speech element sequence that has been obtained via the method shown in FIG. 3. In step 410, a target speech element is spotted in a set of acoustic observations. In step 420, longer speech element sequences are hypothesized, and the hypothesized sequences are matched against the set of acoustic observations. In step 430, a combined speech element sequences is obtained, if such criteria warrant, such as described with reference to FIG. 3. In step 440, a determination is made as to whether a speech recognition stopping criteria has been met. If Yes, then the process is complete. If No, then in step 450, a determination is made as to whether or not all of the set of acoustic observations have been analyzed for target speech element sequences. If Yes, then the process proceeds to step 420. If No, then the process proceeds to step 410, in order to spot target speech element sequences against a remaining portion of the set of acoustic observations.

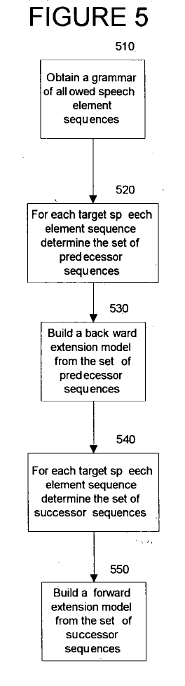

In FIG. 1, step 130 describes the use of forward extension models and backward extension models. FIG. 5 shows a third embodiment of the invention by which forward extension models and backward extension models are created from a grammar. In step 510, a grammar is obtained of allowable speech element sequences. For example, if a user is only allowed to speak a city and state, then the grammar comprises all possible city and state names. In step 520, for each target speech element sequence, a determination is made as to the set of predecessor sequences that are allowable based on the grammar. In step 530, a backward extension model is built from the set of predecessor sequences. FIG. 2 shows a simple example of a backward extension model for the target speech element sequence “California”, in which only cities in California are allowable. In step 540, for each target speech element sequence, a determination is made as to the set of successor sequences that are allowable based on the grammar. In step 550, a forward extension model is built from the set of successor sequences. FIG. 2 shows a simple example of a successor extension model for the target speech element sequence. “California, in which only zip codes for California are allowable based on the grammar.

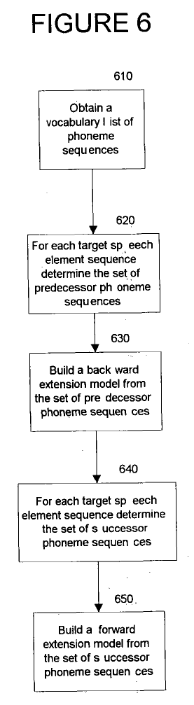

FIG. 6 shows a fourth embodiment of the invention by which forward extension models and backward extension models are created from a vocabulary list of phoneme sequences, whereby the forward and back extension models can be used in step 130 shown in FIG. 1. In step 610, a vocabulary list of allowable phoneme sequences is obtained. In step 620, for each target speech element sequence, a determination is made as to the set of predecessor phoneme sequences that are allowable based on the vocabulary list. In step 630, a backward extension model is built from the set of predecessor sequences. In step 640, for each target speech element sequence, a determination is made as to the set of successor phoneme sequences that are allowable based on the vocabulary list. In step 650, a forward extension model is built from the set of successor phoneme sequences.

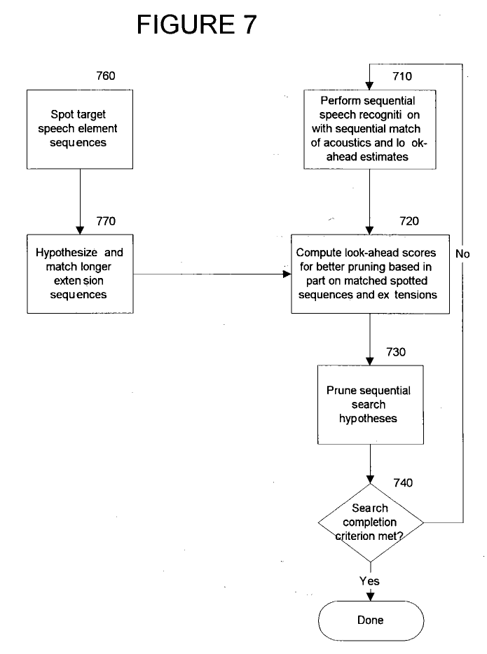

FIG. 7 shows a method of performing speech recognition according to a fifth embodiment of the invention. In step 710, sequential speech recognition is performed on a set of acoustic observations (which can be obtained from input speech being provided to a phonetic decoder, for example), whereby the speech recognition is performed with sequential matching of acoustics and look-ahead estimates, in a manner known to those skilled in the art, such as by way of a priority queue technique. In step 720, look-ahead scores are computed for better pruning based in part of matched spotted target sequences and extensions. In step 730, a pruning is performed on the sequential search hypotheses, to remove the ones that do not match closely to the set of acoustic observations. In step 740, a determination is made as to whether or not the search completion criterion is met. If Yes, then the speech recognition process is complete. If No, then the process proceeds back to step 710.

In step 760, target speech element sequences are spotted in the set of acoustic observations. This step is preferably performed in parallel with the steps 710, 720, 730 and 740. In step 770, longer extension sequences are hypothesized and matched against the set of acoustic observations, and the output of that step is provided to step 720, to be used in the computation of look-ahead scores in that step.

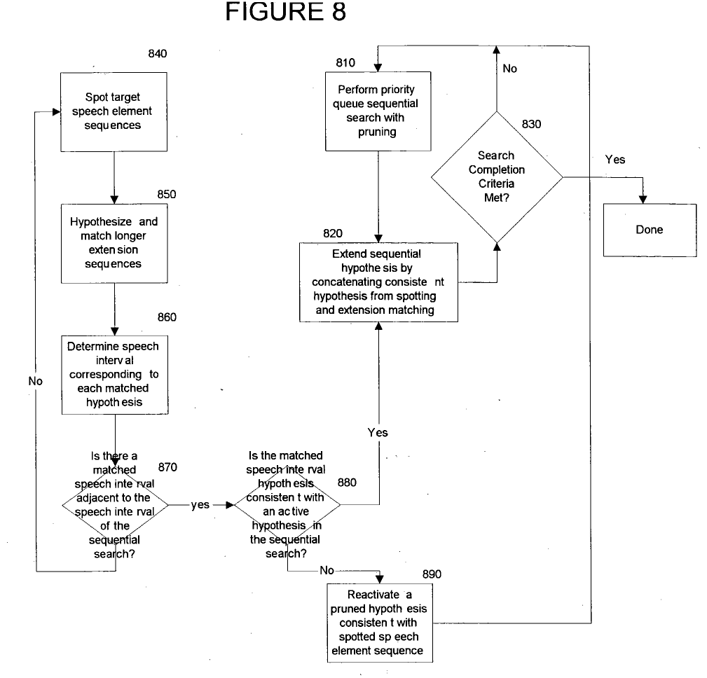

FIG. 8 shows a method of performing speech recognition according to a sixth embodiment of the invention. In step 810, a priority queue sequential search is performed with pruning. In step 820, sequential hypothesis is extended by concatenating consistent hypotheses from target speech element sequence spotting and extension matching. In step 830, a determination is made as to whether or not a search completion criterion is met. If Yes, then the process is complete. If No, then the process returns to step 810. In step 840, target speech element sequences are spotted in a set of acoustic observations. In step 850, longer extension sequences are hypothesized, and the hypotheses are matched against the set of acoustic observations. In step 860, a speech interval corresponding to each matched hypothesis is determined. In step 870, a determination is made as to whether or not there is a matched speech interval adjacent to the speech interval of the priority queue sequential search (that is, the search being performed by steps 810 and 820). If No, then the process returns to step 840. If Yes, then in a step 880 a determination is made as to whether or not the matched speech interval hypothesis is consistent with an active hypothesis in the priority queue sequential search. If Yes, then the process proceeds to step 820, in which no changes are made to the sequential search. If No, then in step 890, a pruned hypothesis (that is, a hypothesis pruned in the priority queue sequential search) is reactivated, whereby the pruned hypothesis is one that is determined to be consistent with the spotted target speech element sequence. The reactivated hypothesis is then provided to step 810, for a next iteration of the priority queue sequential search.

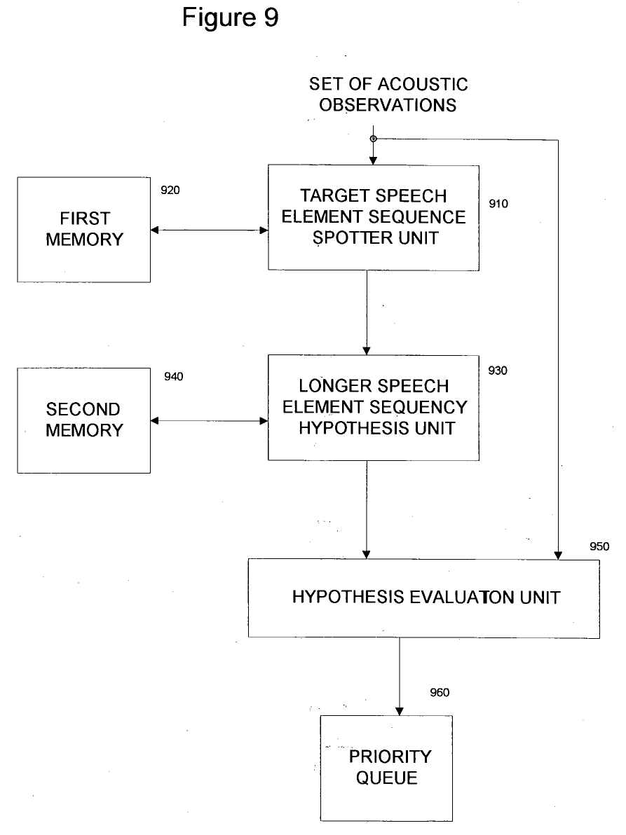

Referring now to FIG. 9, there is shown a speech recognition system 900 that is capable of performing speech recognition according to at least one of the embodiments described previously. The speech recognition system 900 includes a target speech element sequence spotter 910, which spots target speech element sequences against a set of acoustic observations that may correspond to a user's speech to be recognized. The target speech element sequences are stored in a first memory 920, which is accessible by the target speech element sequence spotter 910. The system 900 also includes a longer speech element sequence hypothesis unit 930 which obtains a hypothesis for a longer sequence containing the target spotted target sequence. The longer speech element sequence hypothesis unit 930 utilizes forward and backward extension model information that is stored in a second memory 940, in order to obtain the hypothesis.

The system 900 further includes a hypothesis evaluator 950 that evaluates the longer speech element sequence (obtained from the longer speech element sequence hypothesis unit 930) against the set of acoustic observations. The system 900 also includes a sequential search with pruning unit 960, which may correspond to a priority queue search unit, for example. The sequential search with pruning unit 960 receives input from the hypothesis evaluator 950, to improve the searching performed by the sequential search with pruning unit 960.

In the embodiments described above, the set of acoustic observations may correspond, for example, to a sequence of phonemes, a sequence of words, or a sequence of other speech elements such as syllables. Typically, the sequence of acoustic observations is obtained from a decoder unit that decodes input speech, whereby the decoder unit may output a representation of a set of one or more speech element sequences, such as an n-best list, a phoneme lattice or a word lattice.

In certain aspects, the present invention utilizes similar concepts as described in co-pending application Ser. No. 10/360,915, entitled “System and Method for Priority Queue Searches From Multiple Bottom-Up Detected Starting Points”, which is invented by the same inventor as this application and which is assigned to the same entity as this application, and which is incorporated in its entirety herein by reference. In the present invention, the spotted word n-gram corresponds in some respects to the anchor point or target described in the co-pending application.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A speech recognition method comprising:
obtaining a set of acoustic observations;
obtaining a list of target speech element sequences each containing at least one speech element;
for each target speech element sequence obtaining a forward sequence extension model and a backward sequence extension model;
spotting at least one spotted target speech element sequence by matching the sequence of speech element models against the set of acoustic observations;
obtaining from the set of acoustic observations the set of acoustic observations preceding the said at least one spotted target speech element sequence and the set of acoustic observations following the said at least one spotted target speech element sequence;
obtaining at least one hypothesis of a longer speech element sequence containing the said at least one spotted speech element sequence as a proper subsequence in which said at least one longer speech element sequence is consistent with at least one of said forward sequence extension model and said backward sequence extension model for said at least one spotted speech element sequence; and
evaluating said at least one hypothesis of a longer speech element sequence based on the degree of acoustic match between said longer speech element sequence and at least one of said set of acoustic observations preceding the said at least one spotted target speech element sequence and the set of acoustic observations following the said at least one spotted target speech element sequence.

2. A speech recognition method as in claim 1, further comprising:
spotting a plurality of spotted target speech element sequences in the set of acoustic observations;
determining, for each spotted speech element sequence and each hypothesized longer speech element sequence, the set of acoustic observations that correspond to the speech interval for said speech element sequence;
detecting when the set of acoustic observations for a first speech element sequence and the set of acoustic observations for a second speech element sequence correspond to adjacent speech intervals; and
creating a combined speech element sequence by concatenating said first speech element sequence and said second speech element sequence.

3. A speech recognition method as in claim 2, further comprising:
obtaining from the set of acoustic observations the set of acoustic observations preceding the said at least one combined speech element sequence and the set of acoustic observations following the said at least one combined speech element sequence;
obtaining at least one hypothesis of a longer speech element sequence containing the said at least one combined speech element sequence as a proper subsequence in which said at least one longer speech element sequence is consistent with at least one of said forward sequence extension model of the spotted target speech element sequence contained in said second speech element sequence and said backward sequence extension model for the spotted target speech element sequence contained in said first speech element sequence; and
evaluating said at least one hypothesis of a longer speech element sequence based on the degree of acoustic match between said longer speech element sequence and at least one of said set of acoustic observations preceding the said at least one combined speech element sequence and the set of acoustic observations following the said at least one combined speech element sequence.

4. A speech recognition method as in claim 3, further comprising:
repeating said processes of obtaining at least one hypothesis of a longer speech element sequence, and said evaluating said at least one hypothesis, and said determining of said sets of corresponding acoustic observations, until there is at least one pair of a first speech element sequence and a second element sequence for which it is detected that said first speech element sequence and said second element sequence correspond to adjacent speech intervals;
creating said combined speech element sequence; and
repeating said processes of obtaining and evaluating said longer speech element sequences and of creating said combined speech element sequences until there is at least one hypothesized speech element sequence that corresponds to the complete set of acoustic observations.

5. A speech recognition method as in claim 1, further comprising:
obtaining a grammar of the allowed speech element sequences;
for each allowed target speech element sequence, determining from the grammar the set of predecessor speech element sequences that may precede said target speech element sequence as adjacent subsequences in an allowed speech element sequence;
creating a backward sequence extension model for said target speech element sequence from said set of predecessor speech element sequences;
for each target speech element sequence, determining from the grammar the set of successor speech element sequences that may follow said target speech element sequence as adjacent subsequences in an allowed speech element sequence; and
creating a forward sequence extension model for said target speech element sequence from said set of successor speech element sequences.

6. A speech recognition method as in claim 5, wherein said speech element sequences are word sequences and said grammar is a grammar of allowed word sequences.

7. A speech recognition method as in claim 1, wherein each target speech element sequences is a target phoneme sequence, and wherein the method further comprising:
obtaining a vocabulary list of speech elements each of which is a sequence of phonemes;
for each target phoneme sequence, determining from said vocabulary list the set of predecessor phoneme sequences that may precede said target phoneme sequences as an adjacent phoneme subsequence in the set of phoneme sequences in said vocabulary list;
creating a backward sequence extension model for said target phoneme sequence from said set of predecessor phoneme sequences; and
for each target phoneme sequence, determining from said vocabulary list the set of successor phoneme sequences that may follow said target phoneme sequence as an adjacent phoneme subsequence in the set of phoneme sequences in said vocabulary list.

8. A speech recognition method as in claim 1, wherein the set of acoustic observations is a sequence, and wherein the method further comprising:
performing a sequential speech recognition search substantially simultaneously with said spotting of at least one target speech element sequence; and
using said spotting of at least one speech element sequence to enhance said sequential speech recognition search.

9. A speech recognition method as in claim 8, wherein said sequential speech recognition search is a priority queue search.

10. A speech recognition method as in claim 8, wherein said sequential speech recognition search is a frame synchronous beam search.

11. A speech recognition system, comprising:
means for obtaining a list of target speech element sequences from a set of acoustic observations, each said target speech element sequence containing at least one speech element;
means for obtaining, for each said target speech element sequence, a forward sequence extension model and a backward sequence extension model;
means for spotting at least one spotted target speech element sequence by matching the sequence of speech element models against the set of acoustic observations;
means for obtaining, from the set of acoustic observations, the set of acoustic observations preceding the said at least one spotted target speech element sequence and the set of acoustic observations following the said at least one spotted target speech element sequence;
means for obtaining at least one hypothesis of a longer speech element sequence containing the said at least one spotted speech element sequence as a proper subsequence in which said at least one longer speech element sequence is consistent with at least one of said forward sequence extension model and said backward sequence extension model for said at least one spotted speech element sequence; and
means for evaluating said at least one hypothesis of a longer speech element sequence based on the degree of acoustic match between said longer speech element sequence and at least one of said set of acoustic observations preceding the said at least one spotted target speech element sequence and the set of acoustic observations following the said at least one spotted target speech element sequence.

12. A speech recognition system as in claim 11, further comprising:
means for spotting a plurality of spotted target speech element sequences in the set of acoustic observations;
means for determining, for each spotted speech element sequence and each hypothesized longer speech element sequence, the set of acoustic observations that correspond to the speech interval for said speech element sequence;
means for detecting when the set of acoustic observations for a first speech element sequence and the set of acoustic observations for a second speech element sequence correspond to adjacent speech intervals; and
means for creating a combined speech element sequence by concatenating said first speech element sequence and said second speech element sequence.

13. A speech recognition system as in claim 12, further comprising:
means for obtaining from the set of acoustic observations the set of acoustic observations preceding the said at least one combined speech element sequence and the set of acoustic observations following the said at least one combined speech element sequence;
means for obtaining at least one hypothesis of a longer speech element sequence containing the said at least one combined speech element sequence as a proper subsequence in which said at least one longer speech element sequence is consistent with at least one of said forward sequence extension model of the spotted target speech element sequence contained in said second speech element sequence and said backward sequence extension model for the spotted target speech element sequence contained in said first speech element sequence; and
means for evaluating said at least one hypothesis of a longer speech element sequence based on the degree of acoustic match between said longer speech element sequence and at least one of said set of acoustic observations preceding the said at least one combined speech element sequence and the set of acoustic observations following the said at least one combined speech element sequence.

14. A speech recognition system as in claim 13, further comprising:
means for repeating said processes of obtaining at least one hypothesis of a longer speech element sequence, and said evaluating said at least one hypothesis, and said determining of said sets of corresponding acoustic observations, until there is at least one pair of a first speech element sequence and a second element sequence for which it is detected that said first speech element sequence and said second element sequence correspond to adjacent speech intervals;
means for creating said combined speech element sequence; and
means for repeating said processes of obtaining and evaluating said longer speech element sequences and of creating said combined speech element sequences until there is at least one hypothesized speech element sequence that corresponds to the complete set of acoustic observations.

15. A speech recognition system as in claim 11, further comprising:
means for obtaining a grammar of the allowed speech element sequences;
means for determining, from the grammar for each allowed target speech element sequence, the set of predecessor speech element sequences that may precede said target speech element sequence as adjacent subsequences in an allowed speech element sequence;
means for creating a backward sequence extension model for said target speech element sequence from said set of predecessor speech element sequences;
means for determining from the grammar, for each target speech element sequence, the set of successor speech element sequences that may follow said target speech element sequence as adjacent subsequences in an allowed speech element sequence; and
means for creating a forward sequence extension model for said target speech element sequence from said set of successor speech element sequences.

16. A speech recognition system as in claim 15, wherein said speech element sequences are word sequences and said grammar is a grammar of allowed word sequences.

17. A speech recognition system as in claim 11, wherein each target speech element sequences is a target phoneme sequence, and wherein the system further comprising:
means for obtaining a vocabulary list of speech elements each of which is a sequence of phonemes;
means for determining from the vocabulary list, for each target phoneme sequence, the set of predecessor phoneme sequences that may precede said target phoneme sequences as an adjacent phoneme subsequence in the set of phoneme sequences in said vocabulary list;
means for creating a backward sequence extension model for said target phoneme sequence from said set of predecessor phoneme sequences; and
means for determining from the vocabulary list, for each target phoneme sequence, the set of successor phoneme sequences that may follow said target phoneme sequence as an adjacent phoneme subsequence in the set of phoneme sequences in said vocabulary list.

18. A speech recognition system as in claim 11, wherein the set of acoustic observations is a sequence, and wherein the system further comprising:
means for performing a sequential speech recognition search substantially simultaneously with said spotting of at least one target speech element sequence; and
means for using said spotting of at least one speech element sequence to enhance said sequential speech recognition search.

19. A speech recognition system as in claim 18, wherein said sequential speech recognition search is a priority queue search.

20. A speech recognition system as in claim 18, wherein said sequential speech recognition search is a frame synchronous beam search.

21. A program product having machine readable code for performing speech recognition, the program code, when executed, causing a machine to perform the following steps:
obtaining a list of target speech element sequences each containing at least one speech element;
for each target speech element sequence obtaining a forward sequence extension model and a backward sequence extension model;
spotting at least one spotted target speech element sequence in a set of acoustic observations by matching the sequence of speech element models against the set of acoustic observations;
obtaining from the set of acoustic observations the set of acoustic observations preceding the said at least one spotted target speech element sequence and the set of acoustic observations following the said at least one spotted target speech element sequence;
obtaining at least one hypothesis of a longer speech element sequence containing the said at least one spotted speech element sequence as a proper subsequence in which said at least one longer speech element sequence is consistent with at least one of said forward sequence extension model and said backward sequence extension model for said at least one spotted speech element sequence; and
evaluating said at least one hypothesis of a longer speech element sequence based on the degree of acoustic match between said longer speech element sequence and at least one of said set of acoustic observations preceding the said at least one spotted target speech element sequence and the set of acoustic observations following the said at least one spotted target speech element sequence.

22. A program product as in claim 21, the program code further causing a machine to perform the following steps:
spotting a plurality of spotted target speech element sequences in the set of acoustic observations;
determining, for each spotted speech element sequence and each hypothesized longer speech element sequence, the set of acoustic observations that correspond to the speech interval for said speech element sequence;
detecting when the set of acoustic observations for a first speech element sequence and the set of acoustic observations for a second speech element sequence correspond to adjacent speech intervals; and
creating a combined speech element sequence by concatenating said first speech element sequence and said second speech element sequence.

23. A program product as in claim 21, the program code further causing a machine to perform the following steps:
obtaining from the set of acoustic observations the set of acoustic observations preceding the said at least one combined speech element sequence and the set of acoustic observations following the said at least one combined speech element sequence;
obtaining at least one hypothesis of a longer speech element sequence containing the said at least one combined speech element sequence as a proper subsequence in which said at least one longer speech element sequence is consistent with at least one of said forward sequence extension model of the spotted target speech element sequence contained in said second speech element sequence and said backward sequence extension model for the spotted target speech element sequence contained in said first speech element sequence; and
evaluating said at least one hypothesis of a longer speech element sequence based on the degree of acoustic match between said longer speech element sequence and at least one of said set of acoustic observations preceding the said at least one combined speech element sequence and the set of acoustic observations following the said at least one combined speech element sequence.

24. A program product as in claim 21, the program code further causing a machine to perform the following steps:
repeating said processes of obtaining at least one hypothesis of a longer speech element sequence, and said evaluating said at least one hypothesis, and said determining of said sets of corresponding acoustic observations, until there is at least one pair of a first speech element sequence and a second element sequence for which it is detected that said first speech element sequence and said second element sequence correspond to adjacent speech intervals;
creating said combined speech element sequence; and
repeating said processes of obtaining and evaluating said longer speech element sequences and of creating said combined speech element sequences until there is at least one hypothesized speech element sequence that corresponds to the complete set of acoustic observations.

25. A speech recognition method, comprising:
receiving a set of acoustic observations, and performing a speech recognition on the set of acoustic observations;
at the same time the speech recognition is being performed, determining whether or not an n-gram of speech elements occurs in the set of acoustic observations, wherein n is an integer greater than or equal to one;
if the determination is that an n-gram occurs, then performing at least one of a backward search and a forward search using a continuation tree that represents allowable continuations in a grammar that may precede or follow the spotted n-gram; and
determining a best matching path in the continuation tree with respect to the set of acoustic observations.
